(19) United States
(12) Patent Application Publication
(10) Pub. No.: US 2010/0070375 A1
(43) Pub. Date: Mar. 18, 2010

(54) Personal Information Applications, Personal Information Access Devices, and Methods of Accessing Personal Information

(76) Inventors: Corey D. Lane, Bridgeport, TX (US); Clark E. Lane, Spokane Valley, WA (US); Tim Raczek, Spokane, WA (US)

Correspondence Address: WELLS ST. JOHN P.S., 601 W. FIRST AVENUE, SUITE 1300, SPOKANE, WA, 99201, US

(21) Appl. No.: 12/556,884

(22) Filed: Sep. 10, 2009

Related U.S. Application Data
(60) Provisional application No. 61/096,498, filed on Sep. 12, 2008.

(51) Int. Cl. G06Q 20/00; G06Q 30/00; H04L 9/32

(52) U.S. Cl. 705/17; 726/9

(57) ABSTRACT

Information access methods include determining that a user desires to access restricted information controlled by an information provider and without intervention by the user, accessing user authentication information associated with the information provider, providing the user authentication information to the information provider, and requesting that the information provider authenticate the user authentication information. Subsequent to the requesting, the methods include providing the user with the restricted information. Consumer purchase methods include a consumer establishing communication between a personal access device and a point of sale terminal, the personal access device storing financial information associated with the consumer; the point of sale terminal requesting user authentication information associated with the personal access device from the consumer; based on the user authentication information, the point of sale terminal retrieving the financial information from the personal access device; and securing payment for goods and/or services using the financial information.

### CROSS REFERENCE TO RELATED APPLICATION

This application claims priority under 35 U.S.C. §119 to U.S. Provisional Patent Application Ser. No. 61/096,498 entitled “Personal Information Applications, Personal Information Access Devices, and Methods of Accessing Personal Information”, which was filed Sep. 12, 2008, the entirety of which is incorporated by reference herein.

### TECHNICAL FIELD

The present invention, in various embodiments, relates to personal information applications, personal information access devices, websites, point of sale terminals, and methods of accessing personal information.

### BACKGROUND OF THE DISCLOSURE

With the rise of the Internet, people have become more and more dependent on Internet-based services and on information stored in the Internet “cloud” than on information stored locally on a personal computer. Consequently, many people are becoming less dependent on a particular personal computer or a particular operating system and more dependent on the Internet. In fact, for many daily tasks, such as processing email, making online purchases, and participating in social networking, nearly any personal computer with a web browser may be adequate.

However, gaining access to online information and services can be frustrating. For nearly all online undertakings, one must recall and type an Internet address associated with a website that provides desired online information or a desired service. Furthermore, one must additionally prove his or her identity prior to gaining access to many websites that provide online information or services. Typically, this involves recalling and providing personalized authentication information, such as a username and/or password. For example, a web-based email application may require a user name and password before allowing an individual to access his or her email account.

Further complicating the process of gaining access to online information and services is the fact that in some cases, the personalized authentication information associated with one online service (e.g., a web-based email account) may be different from another online service (e.g., online bank access) increasing the amount of personalized authentication information that one must recall.

Some websites, while not requiring personalized authentication information, may request or require personal information or financial information. For example, online retailers typically require a name, address, email address, credit card number, expiration date, and security code to make a purchase.

As a result of engaging in online services and information, many people now deal with the chore of creating and recalling a large number of user names, passwords, and/or other authentication information. Recalling and typing such information can be time consuming, especially when the same personal information may be repeatedly provided to many different websites, and mentally taxing if many different passwords and/or usernames must be recalled. Recalling the information can be difficult. So difficult, in fact, that many people maintain a paper or electronic list of such information.

However, using a paper or electronic list may be inconvenient because the consumer may need to open the electronic list or find the paper list and copy information from the list into a website. Furthermore, keeping such a list may increase the risk of identity theft since such lists may be easily stolen.

Accordingly, a need exists for a method of quickly recalling and automatically entering Internet addresses, personalized authentication information and other personal information and/or financial information. Such a method could greatly simplify Internet transactions. Since people are increasingly using multiple personal computers in multiple locations (e.g., a home computer and a work computer) to access the Internet, the method should be portable between personal computers rather than relying on software or information stored on one particular personal computer.

Furthermore, a need exists for a method of quickly and efficiently authenticating a consumer to a retailer (e.g., an online retailer or a bricks and mortar retailer) and providing financial account information when conducting a transaction. Such methods would be welcomed by many, especially those who are not computer savvy, do not have a sharp memory, or are not skilled at typing.

### SUMMARY

A software application enables efficient, easy access to commonly used Internet services and information such as email, online shopping, and social networking by enabling a user to login to selected websites with one click of a mouse.

The software application accesses personal information associated with a user. The personal information may include authentication information, such as usernames and passwords; financial information, such as credit or debit card numbers, expiration dates, and security codes; favorite website addresses; and other personal information, such as addresses, phone number, and a social security number.

At the request of the user, the software application uses the personal information to login to websites, make online purchases, and paste personal information into website fields or documents. Doing so greatly increases the efficiency of the user since the user need not recall or type user names, passwords, credit card numbers, addresses, and the like.

The software may secure the personal information by encrypting the personal information and by requiring the user to prove his or her identity, for example with a personal identification number, before allowing access to the personal information.

The user may customize the software application to his or her needs by determining which personal information is available to the software application and to which websites the software is allowed to automatically provide portions or all of the personal information.

These powerful features enable the software to provide the user with easy, customized access to various Internet services and information. Users who are prone to forget personal information, such as passwords; who are not computer savvy; or who cannot type quickly are especially likely to use the software application, as it may greatly reduce their frustration with current methods of accessing Internet services and information.

The software application may be provided to users in a number of different ways. One powerful way is to provide a website from which the software application may be downloaded.

The website may provide a wide variety of content of interest to users of the software application including advertising, an online store, news, helpful tips, social networking, a day planner that supplies text message reminders, and the like. The website may also sell additional functionality or other upgrades to the software application. The content of the website may be targeted at a particular demographic. For example, the content may be targeted at baby boomers, teenagers, college students, senior citizens, or others.

The personal information may be stored in one or more of a number of different places. For example, the personal information may be stored on a computer on which the software application is installed. Alternatively or additionally, the personal information may be stored by the website.

An especially advantageous place to store the personal information is on a personal access device. The personal access device may be a small, highly portable electronic device such as a USB thumb drive. Alternatively, the personal access device may be integrated with other common devices such as a wireless phone.

The personal access device may be configured to communicate with a computer or other device on which the software application is executing, thereby enabling the software application to retrieve the personal information from the personal access device.

The personal access device may securely store the personal information by encrypting the personal information and by requiring user authentication information before allowing access to the personal information.

The personal access device provides a powerful way of consolidating usernames, passwords, credit card information, and other personal information in a single, secure location. The personal access device may eliminate the need to carry a wallet full of credit cards or a piece of paper containing usernames and passwords.

In some configurations, the personal access device may contain programming embodying the software application so that a computer in communication with the personal access device may download the programming from the personal access device and execute the software application. This enables the user to approach nearly any computer having Internet access and quickly and efficiently gain access to Internet services and information via the software application and the personal information, thereby eliminating dependence on a particular computer or device.

Additionally or alternatively, the personal access device may interact with point of sale devices that might not execute the software application, but that can, when authorized, access the personal information to secure payment for goods or services.

To make a purchase, the user may enable communication between the personal access device and the point of sale device, for example by plugging the personal access device into the point of sale device. The point of sale device may then verify the user's identity by asking for authentication information. Once the user has been authenticated, the point of sale device may retrieve financial information describing one or more payment instruments such as credit cards, debit cards, bank accounts, and the like and allow the user to select which payment instrument he or she would like to use for the transaction.

The point of sale device may retrieve account information related to the selected payment instrument from the personal access device and use the account information to pay for the purchase. In some configurations, the point of sale device may provide an electronic receipt detailing the purchase to the personal access device.

Upon completion of the transaction, the user may disable communication between the personal access device and the point of sale terminal, for example by removing the personal access device from the point of sale terminal.

Making purchases in this manner may be highly desirable since the user knows that his or her personal financial information is securely stored and cannot be accessed, even if the personal access device is stolen, as long as the authentication information associated with the personal access device is kept secret.

The point of sale device may be used in retail stores or may be integrated into devices such as gas pumps, parking meters, and vending machines.

### BRIEF DESCRIPTION OF THE DRAWINGS

FIG. 1 illustrates a user interface of a personal information application in a first configuration in accordance with an embodiment of the present disclosure.

FIG. 1A illustrates a user interface of a personal information application in a second configuration in accordance with an embodiment of the present disclosure.

FIG. 1B illustrates a user interface of an email application in accordance with an embodiment of the present disclosure.

FIG. 1C illustrates a user interface of a personal information application in a third configuration in accordance with an embodiment of the present disclosure.

FIG. 1D illustrates a user interface of a banking application in accordance with an embodiment of the present disclosure.

FIG. 1E illustrates a user interface of a personal information application in a fourth configuration in accordance with an embodiment of the present disclosure.

FIG. 1F illustrates a user interface of an online shopping application in accordance with an embodiment of the present disclosure.

FIG. 1G illustrates a user interface of a personal information application in a fifth configuration in accordance with an embodiment of the present disclosure.

FIG. 1H illustrates a user interface of a news application in accordance with an embodiment of the present disclosure.

FIG. 1J illustrates a user interface of a personal information application in a sixth configuration in accordance with an embodiment of the present disclosure.

FIG. 2 illustrates a user interface of a personal information application in a seventh configuration in accordance with an embodiment of the present disclosure.

FIG. 3 illustrates a user interface of a personal information application in an eighth configuration in accordance with an embodiment of the present disclosure.

FIG. 4 illustrates a user interface of a personal information application in a ninth configuration in accordance with an embodiment of the present disclosure.

FIG. 5 illustrates a block diagram of a communications network in accordance with an embodiment of the present disclosure.

FIG. 6 illustrates a block diagram of user computing circuitry in accordance with an embodiment of the present disclosure.

FIG. 7 illustrates a block diagram of server computing circuitry in accordance with an embodiment of the present disclosure.

FIG. 8 illustrates a personal access device in accordance with an embodiment of the present disclosure.

FIG. 9 illustrates a block diagram of a personal access device in accordance with an embodiment of the present disclosure.

FIG. 10 illustrates a point of sale terminal in a first configuration in accordance with an embodiment of the present disclosure.

FIG. 11 illustrates a point of sale terminal in a second configuration in accordance with an embodiment of the present disclosure.

FIG. 12 illustrates another point of sale terminal in accordance with an embodiment of the present disclosure.

FIG. 13 illustrates one aspect of using a personal access device to make a purchase in accordance with an embodiment of the present disclosure.

FIG. 14 illustrates one aspect of retrieving purchase information from a personal access device in accordance with an embodiment of the present disclosure.

FIG. 15 illustrates using a personal access device in conjunction with a wireless communications device in accordance with an embodiment of the present disclosure.

### DESCRIPTION OF THE EMBODIMENTS

A significant number of transactions conducted on the Internet require a user participating in the transaction to supply personal information to participate in the transaction. In some cases, the personal information is required in order to access restricted information (e.g., email, financial account details, etc.) controlled by an information provider (e.g., an email service provider, financial institution, etc.). Such transactions may include banking, online purchases, social networking, email, and other activities. The personal information may include account numbers, passwords, user names, favorite website addresses, and the like. Since the personal information used to conduct a transaction with one party (e.g., a bank) via the Internet need not be the same as personal information used to conduct transactions with other parties (e.g., retailers, other banks, etc.), those who conduct transactions on the Internet with a variety of parties may have a significant amount of personal information that they need to keep handy while using the Internet. To efficiently conduct these transactions some people memorize such information.

According to one embodiment, a personal information application may store the personal information for a user so that the user does not need to memorize the personal information. The user may store the personal information in the personal information application and later (e.g., prior to or while conducting an online transaction) retrieve the personal information from the personal information application.

In one embodiment, the personal information application may be executed by computing circuitry such as one or more of a server, personal computer, cellular phone, smart phone, or a handheld computing device. The computing circuitry, or other circuitry, may display a user interface of the personal information application to a user. The appearance of the user interface and/or information presented by the user interface may be frequently updated by the personal information application.

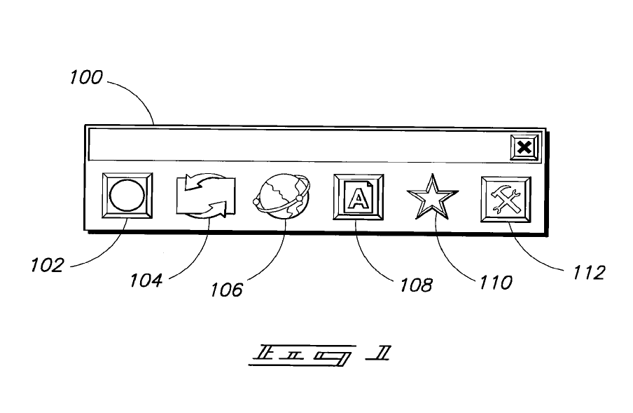

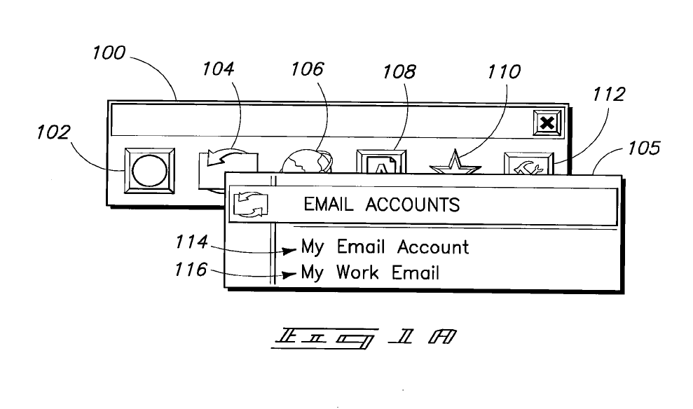

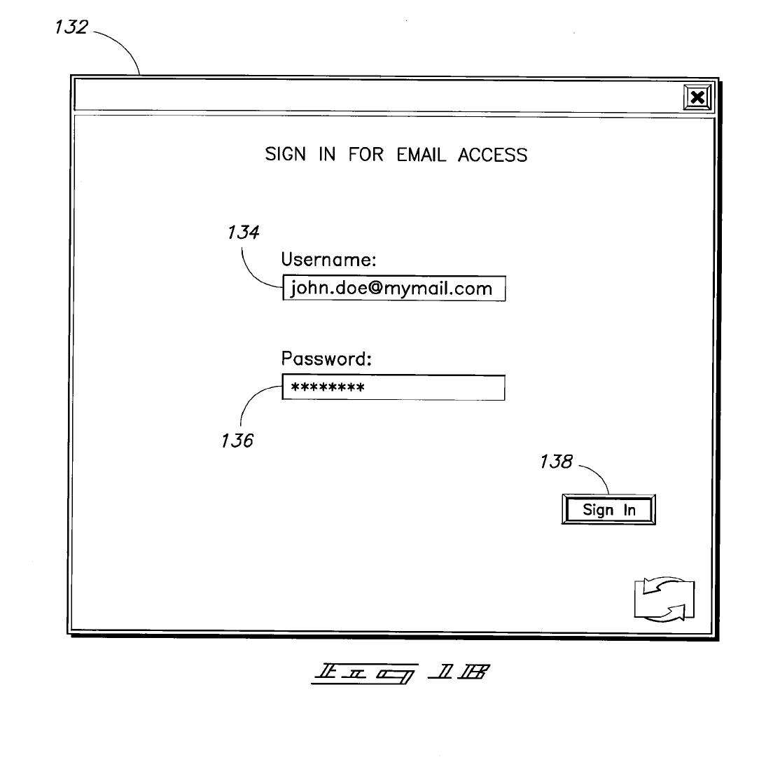

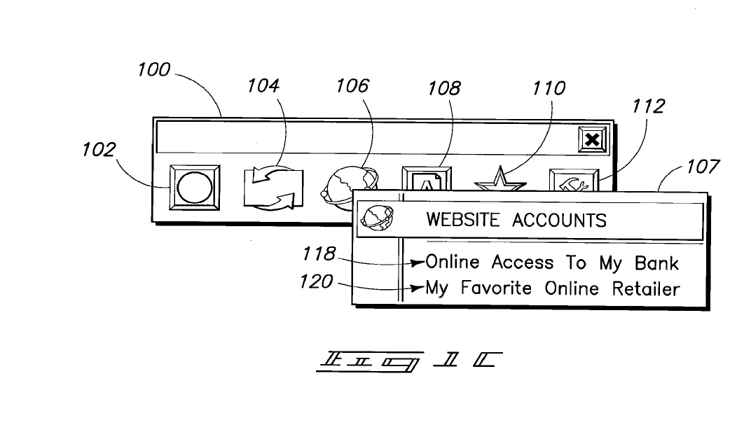

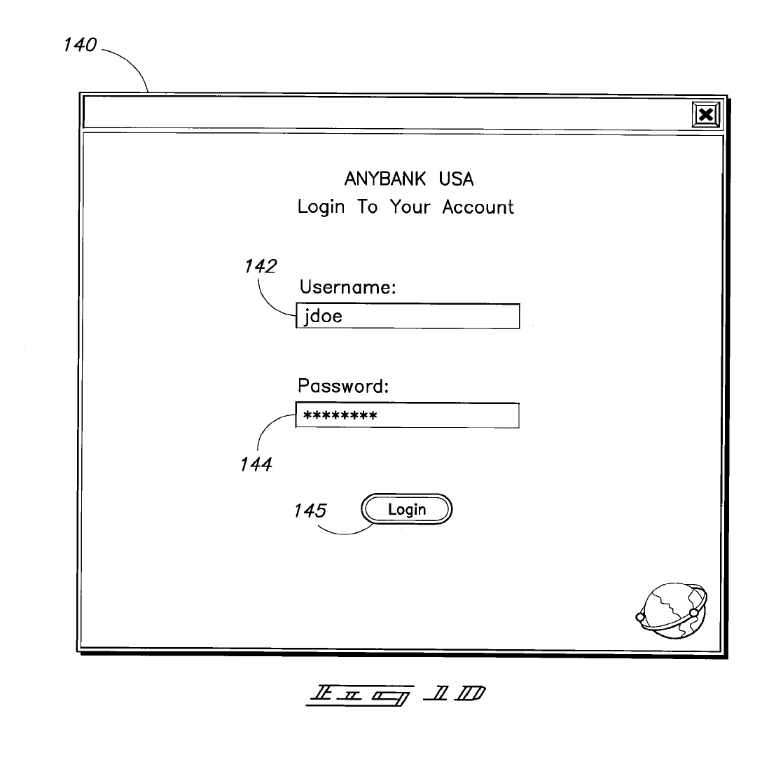

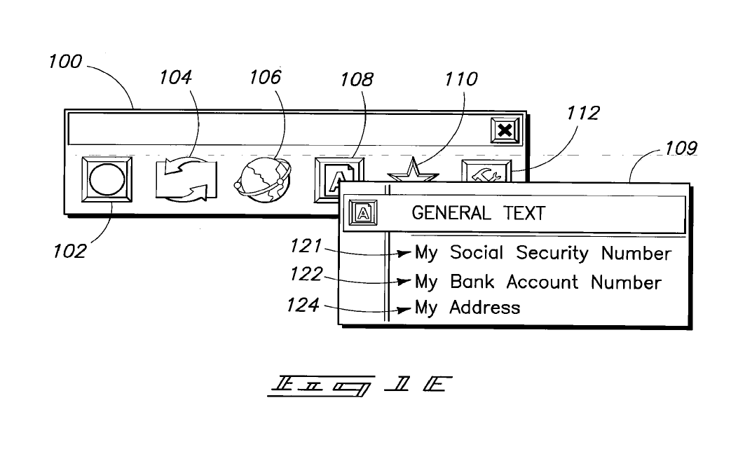

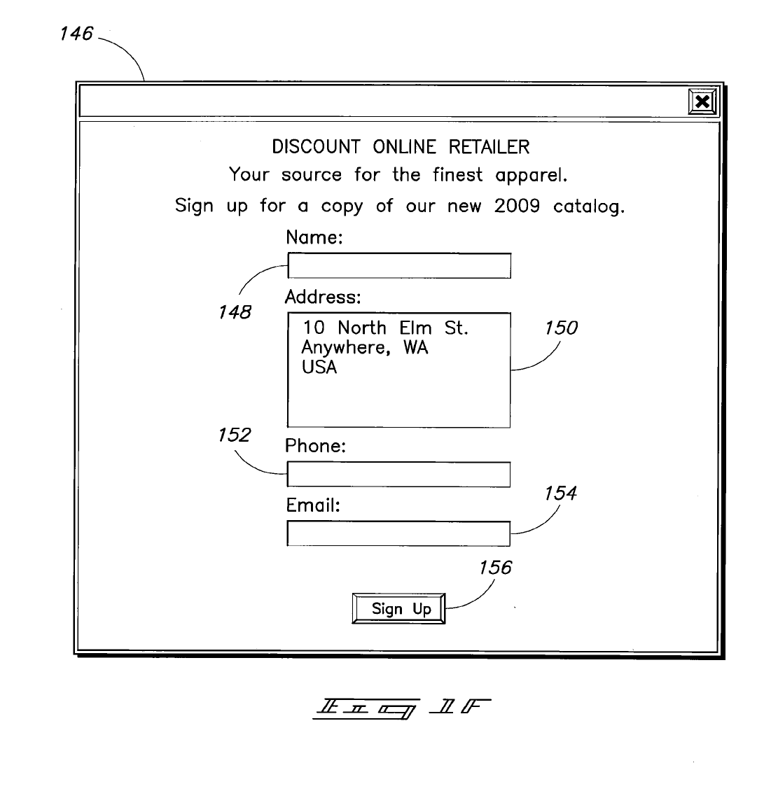

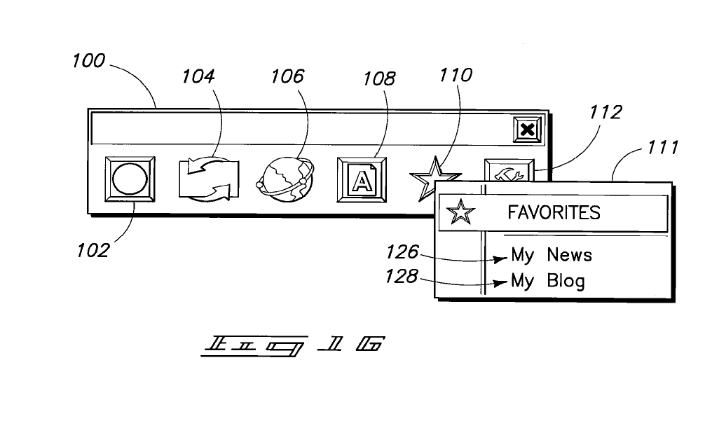

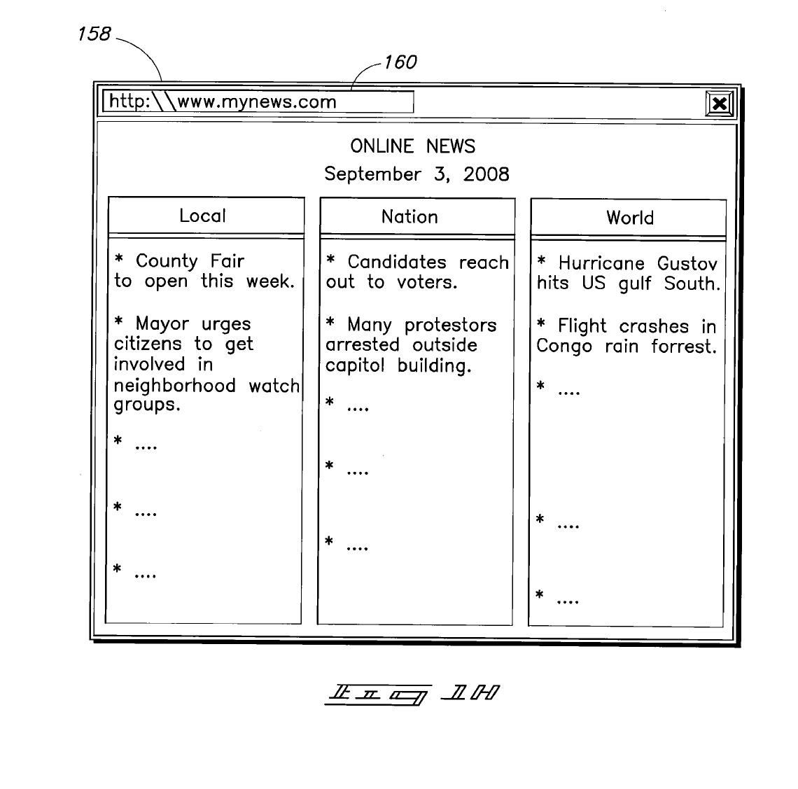

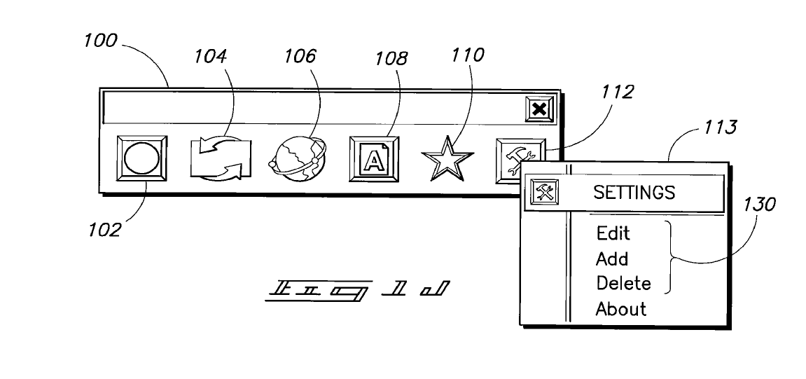

Referring to FIG. 1, one configuration of a user interface 100 of a personal information application is illustrated. User interface 100 includes five user-selectable icons 104, 106, 108, 110, and 112. Selecting one or more of icons 104, 106, 108, 110, or 112 may invoke functionality of the personal information application. In one embodiment, selecting one of the icons may involve positioning a pointer over the icon and might not require a “click” of a mouse button or other pointing device button. Of course, in other embodiments, user interface 100 may include more or fewer user-selectable icons. In some embodiments, the order of icons 104, 106, 108, 110, and 112 may be customized by a user.

In one embodiment, the personal information application may store information related to one or more email accounts. For example, the personal information may include access information associated with an email account such as a URL associated with the email account. The personal information may additionally or alternatively include authentication information associated with the email account. The authentication information may include information used to access email associated with the email account. For example, the authentication information may include a user name and/or a password associated with the email account.

A user may initially provide the information associated with the email account (e.g., the access information and the authentication information) to the personal information application. The personal information application may subsequently store the information so that the user need not remember the information.

FIG. 1A illustrates a configuration of user interface 100 in which icon 104 has been selected (e.g., by positioning a pointer over icon 104). As a result of the selection, a menu 105 is displayed. Menu 105 includes example entries “My Email Account” 114 and “My Work Email” 116. Of course, in other embodiments, menu 105 may include more or fewer entries. In some embodiments, the order of the entries of menu 105 may be user configurable.

Example entries 114 and 116 may be associated with different email accounts relative to one another. Entry 114 may be associated with a first set of personal information associated with a first email account (e.g., first access information and first authentication information) and entry 116 may be associated with a second set of personal information associated with a second email account (e.g., second access information and second authentication information). The personal information application may store the first set of personal information and the second set of personal information.

Upon selection of one of entries 114 or 116 by a user (e.g., by clicking on one of entries 114 or 116 using a pointing device such as a mouse), the personal information application may provide access to the email account associated with the selected entry. For example, in one embodiment, the personal information application may open a new web browser window (or use an existing web browser window) and direct the web browser to a URL using the access information associated with the selected entry. The personal information application may also use the authentication information associated with the selected entry to gain access to the email account. For example, the personal information application may provide a user name and password to a server hosting the email account.

Furthermore, the personal information application may cause the server to process the authentication information. For example, if a button is normally presented on a login web page associated with the email account, which must be pressed before the server will process authentication information entered on the login page, the personal information application may perform an operation equivalent to pushing the button. For example, the personal information application may send a message to the server, call an API associated with the server, or perform another action effective to cause the server to process the authentication information.

Referring to FIG. 1B, a login web page 132 for an email account is illustrated. Login web page 132 includes a username field 134, a password field 136, and a sign in button 138. As was described above, in response to a user selecting entry 114 of user interface 100, the personal information application may open login web page 132, populate username field 134 with a username associated with the email account, and populate password field 136 with a password associated with the email account. The username and password may be part of the first set of personal information described above.

After populating fields 134 and 136, the personal information application may perform an operation equivalent to pushing sign in button 138, causing the server associated with login web page 132 to process the username and password. As a result, the server may next grant access to the email account, for example, by presenting a web page configured to allow a user to read received email and compose new email.

Accordingly, as a result of the user selecting the selected entry (e.g., entry 114 or 116 of FIG. 1A), the user may gain access to the email account associated with the selected entry without having to remember or type the authentication information. In one embodiment, selecting the selected entry may be performed with a single “click” (e.g., pressing a mouse button once) when a pointer is over the selected entry since selecting icon 104 to reveal menu 105 may involve positioning a pointer over icon 104 but might not require a user to “click” on icon 104.

In some embodiments, after selecting the selected entry, the user need not physically perform further actions (such as mouse clicks) to gain access to the email account associated with the selected entry other than to select the entry (e.g., entry 114 or 116) associated with the email account.

In one embodiment, the personal information application may store information related to one or more websites. The information may include access information associated with the website, for example, a URL associated with the website. The information may additionally or alternatively include authentication information associated with the website. The authentication information may include information used to access the website and/or log in to the website such as a user name and/or a password associated with the website.

Such authentication information is becoming increasingly common for websites. For example, online retailers, financial institutions, and social networking sites may request and/or require authentication information. The authentication information may be used to customize content displayed on the website subsequent to validating the authentication information and/or to allow access to restricted information not generally available to the public. In some cases, logging into a website may provide a user with access to information not otherwise available, such as personal account information (e.g., bank account information).

A user may initially provide the information associated with the website (e.g., the access information and the authentication information) to the personal information application. The personal information application may subsequently store the information so that the user need not remember the information.

FIG. 1C illustrates a configuration of user interface 100 in which icon 106 has been selected (e.g., by positioning a pointer over icon 106). As a result of the selection, a menu 107 is displayed. Menu 107 includes example entries “Online Access to My Bank” 118 and “My Favorite Online Retailer” 120. Of course, in other embodiments, menu 107 may include more or fewer entries. In some embodiments, the order of the entries of menu 107 may be user configurable.

Example entries 118 and 120 may be associated with different websites relative to one another. Entry 118 may be associated with a first set of personal information associated with a financial institution website (e.g., first access information and first authentication information) and entry 120 may be associated with a second set of personal information associated with a retailer website (e.g., second access information and second authentication information). The personal information application may store the first set of personal information and the second set of personal information.

Upon selection of one of entries 118 or 120 by a user (e.g., by clicking on one of entries 118 or 120 using a pointing device such as a mouse), the personal information application may provide access to the website associated with the selected entry. For example, in one embodiment, the personal information application may open a new web browser window (or use an existing web browser window) and direct the web browser to a URL using the access information associated with the selected entry. The personal information application may also use the authentication information associated with the selected entry to gain access to the website. For example, the personal information application may provide a user name and password to a web server hosting the website.

Furthermore, the personal information application may cause the web server to process the authentication information. For example, if a button is normally presented on a login web page associated with the website, which must be pressed before the web server will process authentication information entered on the login page, the personal information application may perform an operation equivalent to pushing the button. For example, the personal information application may send a message to the web server, call an API associated with the web server, or perform another action effective to cause the web server to process the authentication information.

Referring to FIG. 1D, a login web page 140 for a banking website is illustrated. Login web page 140 includes a username field 142, a password field 144, and a login button 145. As was described above, in response to a user selecting entry 118 of user interface 100, the personal information application may open login web page 140, populate username field 142 with a username associated with the website, and populate password field 144 with a password associated with the website. The username and password may be part of the first set of personal information described above.

After populating fields 142 and 144, the personal information application may perform an operation equivalent to pushing login button 145, causing the server associated with login web page 140 to process the username and password. As a result, the server may next grant access to the bank account, for example, by presenting a web page configured to allow a user to review records associated with the bank account.

Accordingly, as a result of the user selecting the selected entry (e.g., entry 118 or 120), the user may gain access or log in to the website associated with the selected entry without having to remember or type authentication information. In one embodiment, selecting the selected entry may be performed with a single “click” (e.g., pressing a mouse button once) when a pointer is over the selected entry since selecting icon 106 to reveal menu 107 may involve positioning a pointer over icon 106 but might not require a user to “click” on icon 106.

In some embodiments, after selecting the selected entry, the user need not physically perform further actions (such as mouse clicks) to gain access to the website associated with the selected entry other than to select the entry (e.g., entry 114 or 116) associated with the website.

In one embodiment, the authentication information may include information in addition to or instead of a user name and/or password. Generally, the authentication information may be any information used to access or log in to a website. A user may initially provide this information to the personal information application.

In one embodiment, in addition to or instead of storing access information and authentication information for a website, the personal information application may store other information related to the website. For example, the personal information application may store payment information (e.g., credit card numbers, expiration dates, security codes, etc.) and supply the payment information to the website in response to a user action (e.g., the user selecting an entry in menu 105).

In one embodiment, the personal information application may store personal information that the personal information application can recall and provide to a user or another application (e.g., a website and/or a word processor). The personal information may include information associated with a user such as a social security number, address, telephone number, account number, user name, password, and the like.

A user may initially provide the personal information to the personal information application. The personal information application may subsequently store the personal information so that the user need not remember the personal information.

FIG. 1E illustrates a configuration of user interface 100 in which icon 108 has been selected (e.g., by positioning a pointer over icon 108). As a result of the selection, a menu 109 is displayed. Menu 109 includes example entries “My Social Security Number” 121, “My Bank Account Number” 122, and “My Address” 124. Example entries 121, 122, and 124 may be associated with different personal information relative to one another. Of course, in other embodiments, menu 109 may include more or fewer entries. In some embodiments, the order of the entries of menu 109 may be user configurable.

Upon selection of one of entries 121, 122, or 124 by a user (e.g., by clicking on one of entries 114 or 116 using a pointing device such as a mouse), the personal information application may provide the personal information associated with the selected entry to another application (e.g., via a clipboard or via an API). In one configuration, the personal information application may ask the user to verify that he wants to provide the personal information to the other application prior to providing the personal information to the other application.

In one embodiment, the personal information application may paste the personal information associated with the selected entry into another application (e.g., an application that the user was using just prior to selecting the selected entry). In another embodiment, the personal information application may prompt the user to identify an application to which the personal information application will provide the personal information associated with the selected entry.

For example, the user may be viewing a web page containing a field in which the user's social security number is to be entered. The user may click in the field. Next, the user may switch focus to the personal information application and select entry 121. In response, the personal information application may paste the personal information associated with entry 121 (i.e., the user's social security number) into the field of the web page. As a result, the user has populated the field of the web page with his social security number without having to remember or type his social security number.

In another example, the user may wish to view his bank account number in order to relay the bank account number via telephone to a bank employee. To do so, the user may select entry 122. In response, the personal information application may display the bank account number to the user.

In some cases, a user may choose to store the personal information in the personal information application even though the user has the personal information memorized because the user may want to be able to provide the personal information without having to type the personal information. For example, the user may store his address in the personal information application and use the personal information application (specifically entry 124) to paste the address into websites using the methods described above. Doing so may save the user time compared with having to type the address into the websites.

Referring to FIG. 1F, a retailer web page 146 is illustrated. Retailer web page 146 includes a name field 148, an address field 150, a phone number field 152, an email address field 154, and a sign up button 156. Retailer web page 146 provides a way for a consumer to sign up to receive a catalog. Such web pages are very common.

By way of example, a user may browse to retailer web page 146 and may decide to sign up for a catalog. Rather than typing in the personal information requested by retailer web page 146, the user may use the personal information application to fill in the fields of retailer web page 146.

For example, the user may click in address field 150 and then select entry 124 of user interface 100. In response, the personal information application may populate address field 150 with a previously stored address that the user supplied to the personal information application. The user may similarly use the personal information application to populate name field 148, phone number field 152, and email address field 154. Once all of the fields of retailer web page 146 have been populated, the user may then push sign up button 156.

In one embodiment, the personal information application may store website address information (e.g., URLs) selected by a user. In addition to including an address of a website, the address information may include a nickname or label for the website. A user may initially provide the address information to the personal information application. The personal information application may subsequently store the address information so that the user need not remember the address information.

FIG. 1G illustrates a configuration of user interface 100 in which icon 110 has been selected (e.g., by positioning a pointer over icon 110). As a result of the selection, a menu 111 is displayed. Menu 111 includes example entries “My News” 126 and “My Blog” 128. Example entries 126 and 128 may be associated with different address information relative to one another. Of course, in other embodiments, menu 111 may include more or fewer entries. In some embodiments, the order of the entries of menu 111 may be user configurable.

Upon selection of one of entries 126 or 128 by a user (e.g., by clicking on one of entries 126 or 128 using a pointing device such as a mouse), the personal information application may provide access to the website associated with the selected entry. For example, in one embodiment, the personal information application may open a new web browser window (or use an existing web browser window) and direct the web browser to a URL using the address information associated with the selected entry.

Referring to FIG. 1H, a web browser window 158 is illustrated. Web browser window 158 includes address field 160. Web browser window 158 may be configured to display information associated with an address entered in address field 160. As was described above, in response to a user selecting entry 126 of user interface 100, the personal information application may open web browser window 158, populate address field 160 with an address associated with entry 126, and cause web browser window 158 to display information associated with the address populated in address field 160.

A user may provide personal information to the personal information application via user interface 100. Furthermore, the user may edit personal information stored by the personal information application and remove personal information from the personal information application.

FIG. 1J illustrates a configuration of user interface 100 in which icon 112 has been selected. As a result of the selection, a menu 113 is displayed. Menu 113 includes example entries “Edit,” “Add,” and “Delete” 130. A user may select one or more of these entries to modify the personal information stored by the personal information application. For example, by selecting the “Edit” entry, a user may edit existing personal information already stored by the personal information application. By selecting the “Add” entry, the user may add additional personal information to the personal information application and by selecting the “Delete” entry the user may remove some or all of the personal information currently stored by the personal information application from the personal information application.

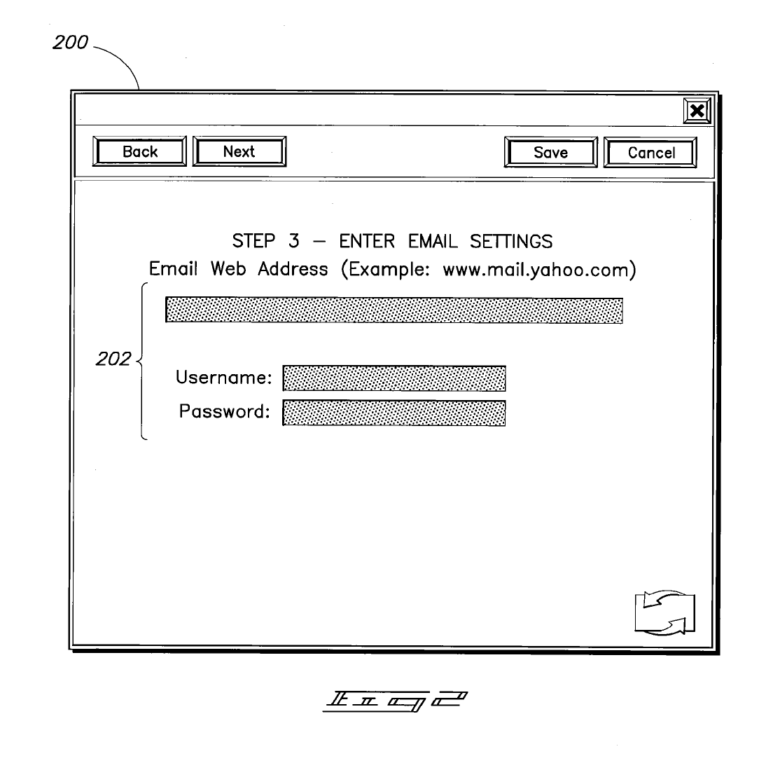

FIG. 2 illustrates a user interface 200 of the personal information application that may be used to add access information and authentication information associated with an email account to the personal information application. User interface 200 includes text entry fields 202.

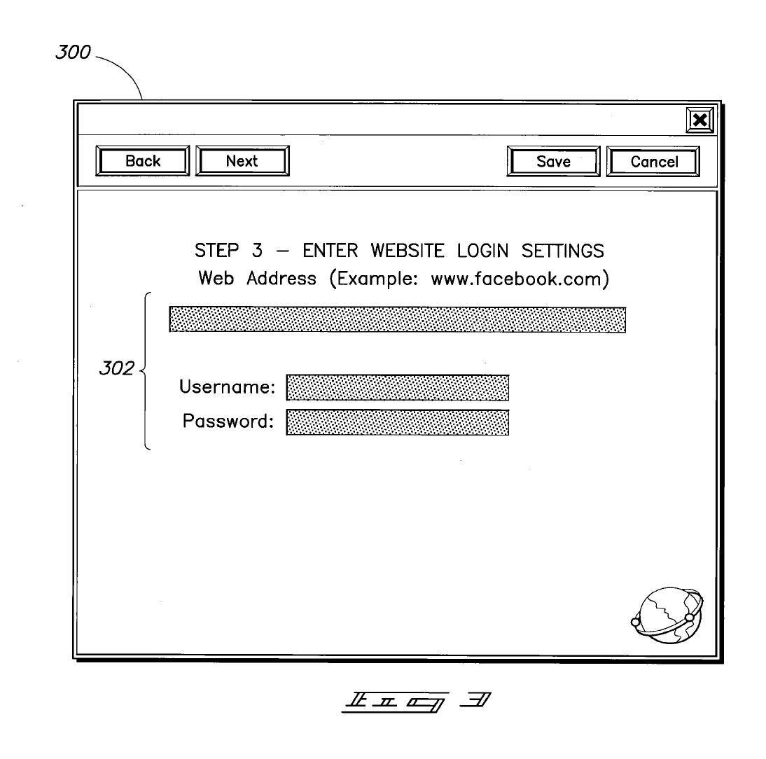

FIG. 3 illustrates a user interface 300 of the personal information application that may be used to add access information and authentication information associated with a website to the personal information application. User interface 300 includes text entry fields 302.

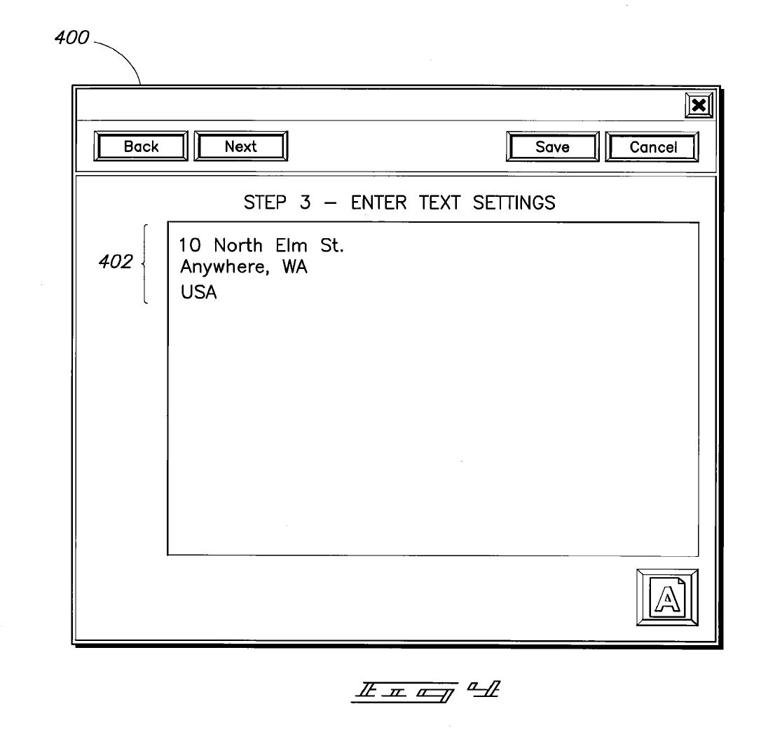

FIG. 4 illustrates a user interface 400 of the personal information application that may be used to add personal information 402 to the personal information application.

The personal information application may prevent unauthorized access to the personal information stored by the personal information application. For example, the personal information application may require that a user authenticate himself prior to the personal information application presenting user interface 100 (illustrated above in FIG. 1) to the user.

In one embodiment, the personal information application may prompt the user to enter user authentication information prior to allowing access. The personal information application may then validate the user authentication information. If the user authentication information is valid, the personal information application may allow access to the personal information stored by the personal information application, for example, via user interface 100.

In one embodiment, the user authentication information may be textual information (e.g., a password or personal identification number (PIN)) entered using a keyboard or keypad. In another embodiment, the user authentication information may be biometric information. To supply this information, the user may, by way of example, scan his fingerprint, submit his eye to a retinal scan, or speak into a microphone. In some embodiments, both biometric and textual information may be provided to the personal information application.

In one embodiment, the personal information application may be configured to be easily accessible to a user while the user is using a different application. For example, the personal information application may include an icon 102 (illustrated in FIG. 1). Icon 102 may remain visible to the user even if the user is using an application other than the personal information application (e.g., a web browser) even though other portions of user interface 100 might not be visible to the user. Consequently, while using the other application, the user can conveniently switch focus to the personal information application.

For example, the user may be browsing a web page. While browsing, the user may decide to enter his address into a field in the web page. To do so, the user may click on icon 102, which is visible to the user while browsing the web page. As a result, user interface 100 may be brought into focus so that the user may conveniently select icon 108 and entry 124.

The personal information application described herein may be executed by various embodiments of computing circuitry. Several of these embodiments will now be described.

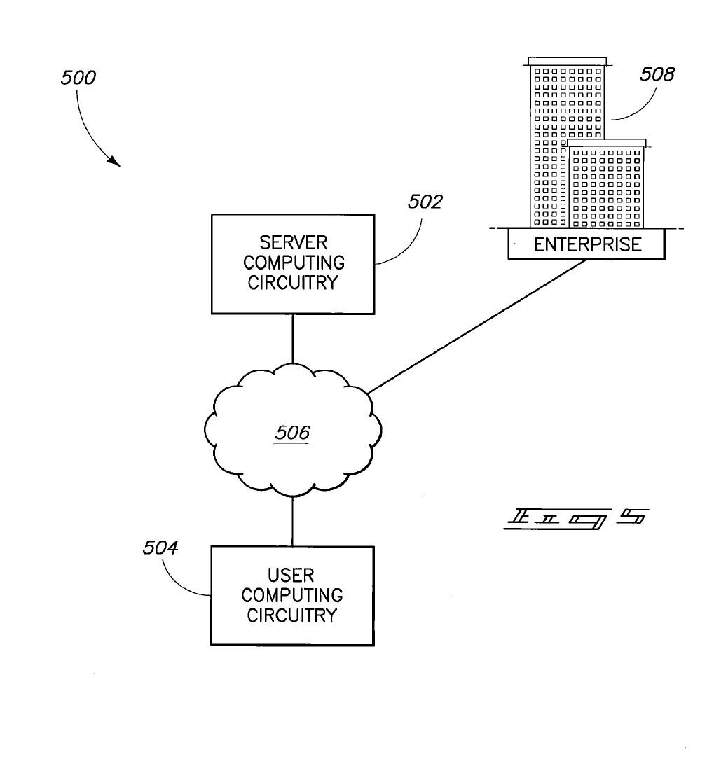

Referring to FIG. 5, a network 500 is illustrated. Network 500 includes server computing circuitry 502, network 506, user computing circuitry 504, and enterprise 508. In one embodiment, network 506 may include the Internet and/or one or more private data networks.

Server computing circuitry 502 may host a website made available to user computing circuitry 504, which may be configured to execute a web browser application. Accordingly, user computing circuitry 504 may receive communications from server computing circuitry 502 via network 506 including information configured to be displayed by the web browser. Similarly, enterprise 508 may also host a website made available to user computing circuitry 504 via network 506. In some cases, enterprise 508 may provide an email service or may provide the ability to purchase goods and/or services via user computing circuitry 504. Thus, enterprise 508 may be referred to as an information provider.

At least some embodiments or aspects described herein may be implemented using programming stored within appropriate processor-usable media and/or communicated via a network or other transmission media and configured to control appropriate processing circuitry. For example, programming may be provided via appropriate media including, for example, embodied within articles of manufacture, embodied within a data signal (e.g., modulated carrier wave, data packets, digital representations, etc.) communicated via an appropriate transmission medium, such as a communication network (e.g., the Internet and/or a private network), wired electrical connection, optical connection and/or electromagnetic energy, for example, via a communications interface, or provided using other appropriate communication structure or medium. Exemplary programming, including processor-usable code, may be communicated as a data signal embodied in a carrier wave in but one example. In some cases, the programming may be referred to as software, hardware, or firmware.

Media storing the programming may be electronic, magnetic, optical, electromagnetic, infrared, or semiconductor media. Some more specific examples of articles of manufacture including media with programming include, but are not limited to, a portable magnetic computer diskette (such as a floppy diskette or a ZIP® disk manufactured by the Iomega Corporation of San Diego, Calif.), hard drive, random access memory, read only memory, flash memory, cache memory, and/or other configurations capable of storing programming, data, or other digital information.

In one embodiment, the personal information application described herein may be embodied as programming. User computing circuitry 504 may execute this programming. In some embodiments, user computing circuitry 504 may download the programming from server computing circuitry 502 via network 506.

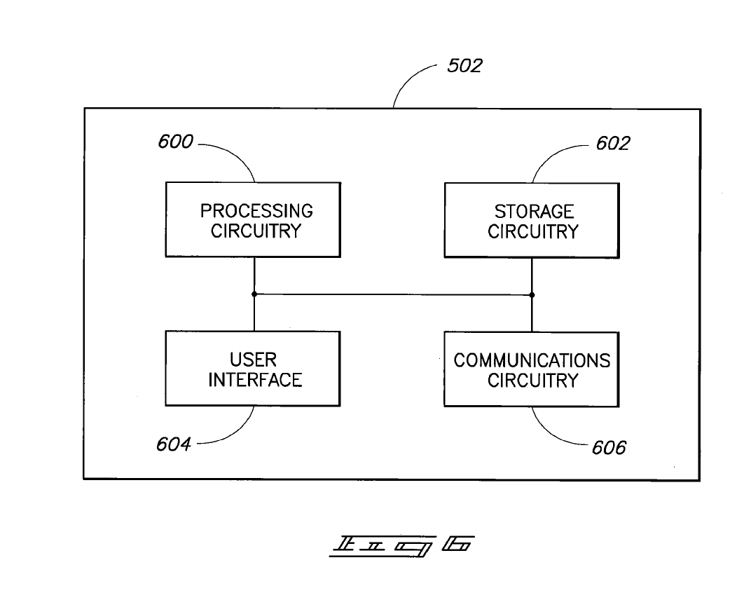

Referring to FIG. 6, a block diagram of server computing circuitry 502 is illustrated. In one embodiment, server computing circuitry 502 includes processing circuitry 600, storage circuitry 602, user interface 604, and communications circuitry 606.

Processing circuitry 600 may comprise circuitry configured to implement desired programming provided by appropriate media in at least one embodiment. For example, processing circuitry 600 may be implemented as one or more of a processor and/or other structure configured to execute executable instructions including, for example, software and/or firmware instructions, and/or hardware circuitry. Exemplary embodiments of processing circuitry 600 include hardware logic, PGA, FPGA, ASIC, state machines, and/or other structures alone or in combination with a processor. These examples of processing circuitry 600 are for illustration and other configurations are possible.

As will be discussed further below, processing circuitry 600 may execute a variety of programming including programming embodying one or more of a web server or the personal information application described herein.

Storage circuitry 602 may be embodied in a number of different ways using electronic, magnetic, optical, electromagnetic, or other techniques for storing information. Some specific examples of storage circuitry include, but are not limited to, a portable magnetic computer diskette, such as a floppy diskette, zip disk, hard drive, random access memory, read only memory, flash memory, cache memory, and/or other configurations capable of storing programming, data, or other digital information. In one embodiment, storage circuitry 602 may store programming implemented by processing circuitry 600.

User interface 604 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface may include a display (e.g., cathode ray tube, LCD, etc.) configured to depict visual information and an audio system as well as a keyboard, mouse and/or other input device. Any other suitable apparatus for interacting with a user may also be utilized.

Communications circuitry 606 is configured to communicate with other circuitry such as user computing circuitry 504 and/or devices within network 506. Communications circuitry 606 may communicate with the other circuitry using one or more of a variety of communication channels including wired and/or wireless communication channels. In one embodiment, communications circuitry 606 may include a network interface card such as an Ethernet network interface card.

By way of example, server computing circuitry 502 may be embodied as one or more computers, servers, server blades, or other computing devices.

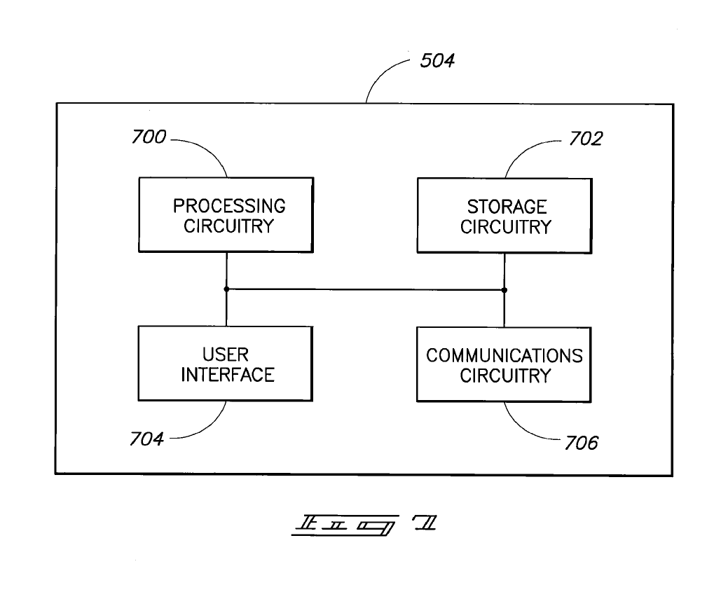

Referring to FIG. 7, a block diagram of user computing circuitry 504 is illustrated. In one embodiment, user computing circuitry 504 includes processing circuitry 700, storage circuitry 702, user interface 704, and communications circuitry 706.

Processing circuitry 700 may comprise circuitry configured to implement desired programming provided by appropriate media in at least one embodiment. For example, processing circuitry 700 may be implemented as one or more of a processor and/or other structure configured to execute executable instructions including, for example, software and/or firmware instructions, and/or hardware circuitry. Exemplary embodiments of processing circuitry 700 include hardware logic, PGA, FPGA, ASIC, state machines, and/or other structures alone or in combination with a processor. These examples of processing circuitry 700 are for illustration and other configurations are possible.

As will be discussed further below, processing circuitry 700 may execute a variety of programming including programming embodying the personal information application described herein.

Storage circuitry 702 may be embodied in a number of different ways using electronic, magnetic, optical, electromagnetic, or other techniques for storing information. Some specific examples of storage circuitry include, but are not limited to, a portable magnetic computer diskette, such as a floppy diskette, zip disk, hard drive, random access memory, read only memory, flash memory, cache memory, and/or other configurations capable of storing programming, data, or other digital information. In one embodiment, storage circuitry 702 may store programming executed by processing circuitry 700 including programming embodying the personal information application described herein.

User interface 704 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface may include a display (e.g., cathode ray tube, LCD, etc.) configured to depict visual information and an audio system as well as a keyboard, mouse and/or other input device. Any other suitable apparatus for interacting with a user may also be utilized.

Communications circuitry 706 is configured to communicate with other circuitry such as server computing circuitry 502, personal access device 800 (described below), and/or devices within network 506. Communications circuitry 706 may communicate with the other circuitry using one or more of a variety of communication channels including wired and/or wireless communication channels. By way of example, communications circuitry 706 may include one or more of a network interface card such as an Ethernet network interface card, a USB interface, an RFID interrogator, or a wireless transceiver.

By way of example, user computing circuitry 504 may be embodied as one or more personal computers, personal digital assistants, cellular phones, smart phones, point of sale terminals, or other computing devices.

In one embodiment, the personal information application described herein may be executed by user computing circuitry 504. Accordingly, the personal information application may be configured to be executed by a particular operating system supported by user computing circuitry 504. For example, in one embodiment the personal information application may be a Microsoft WINDOWS® application. Upon executing the personal information application, user interfaces such as the user interfaces illustrated in FIGS. 1-4 may be presented to a user of the personal information application.

In one embodiment, the personal information application may be stored in storage circuitry 702 of user computing circuitry 504 and may be executed by processing circuitry 700. Furthermore, user interface 704 may present the user with user interfaces such as those illustrated in FIGS. 1-4. User computing circuitry 504 may use communications circuitry 706 to send personal information stored by the personal information application in storage circuitry 702 to websites in order to log into a website such as an email website or retailer website as discussed above in relation to FIGS. 1A and 1B.

Programming embodying the personal information application may be uploaded from an article of manufacture described above (e.g., a compact disk) into storage circuitry 702. Alternatively, the programming may be received from server computing circuitry 502 via communications circuitry 706.

In one embodiment, the personal information application may store personal information in storage circuitry 702 of user computing circuitry 504. The user associated with the personal information application that provided the personal information to the personal information application may own or control user computing circuitry 504. By storing the personal information in storage circuitry 702, the user may obtain a particular peace of mind since user computing circuitry 504 may be under the user's control.

In another embodiment, the personal information application may store the personal information in storage circuitry 602 of server computing circuitry 502. Doing so may provide some advantages. For example, if the personal information is stored in storage circuitry 602, the user might not be restricted to using user computing circuitry 504 to access the personal information. Indeed, the user may use other devices that have access to the personal information application as long as the other devices are in communication with server computing circuitry 502.

Of course, in this embodiment, server computing circuitry 502 may be configured to prevent the personal information from being made available unless the user first provides correct user authentication information (described above).

If the personal information is stored in storage circuitry 702, processing circuitry 700 may encrypt the personal information prior to storing the personal information so that the personal information cannot easily be surreptitiously obtained. In this case, when retrieving the personal information from storage circuitry 702, the personal information may need to be decrypted before it is usable by the personal information application.

In some cases, an encryption technique used to encrypt the personal information may utilize the user authentication information associated with the personal information, for example, as a key for encrypting and/or decrypting the personal information. Various commonly known encryption/decryption techniques may be used for the personal information.

In another embodiment, the personal information application may be embodied as programming that executes within a web browser application on user computing circuitry 504. In this embodiment, the programming may initially be located on server computing circuitry 502. Upon receiving a request from a web browser application being executed on user computing circuitry 504, server computing circuitry 502 may transfer a portion or all of the programming to user computing circuitry 504. User computing circuitry 504 may subsequently execute the programming within the web browser.

In this embodiment, the personal information may be stored in storage circuitry 702 (as described above) even though the programming embodying the personal information application might not be permanently or fully stored in storage circuitry 702. Alternatively, the personal information may be stored in storage circuitry 602 (as described above). The personal information may be stored in both storage circuitry 602 and storage circuitry 702. In this case, one version of the stored personal information (either the version stored in storage circuitry 602 or the version stored in storage circuitry 702) may be a primary version and the other version may be a backup version used if the primary version is corrupted, deleted, or is otherwise unavailable.

Embodying the personal information application as programming that executes within a web browser may be advantageous since it may enable a user to use the personal information application on a variety of user computing circuitry devices instead of being restricted to a particular user computing circuitry device on which the personal information is stored. For example, the personal information application may be accessed and executed using substantially any computer or device connected to the Internet that is capable of executing a web browser.

As was described above, server computing circuitry 502 may provide programming embodying the personal identification application to user computing circuitry 504. In one embodiment, server computing circuitry 502 may be configured as a web server hosting a website. The website may have a link which a user may click to download the programming embodying the personal identification application.

In some embodiments, the website may have additional functionality as well. For example, the website may allow a user to download the programming embodying the personal identification application without charge. However, initially the programming may purposely limit the capability of the personal identification application (e.g., by limiting the number of personal information entries that may be stored by the personal information application). The website may be configured, however, to increase the capability of the personal information application downloaded by a user in exchange for receiving payment from the user. For example, the user may pay a fee in order to be able to store additional entries of personal information using the personal information application.

Alternatively, the website may allow a user to download the programming and the programming may be fully functional. However, the programming may be configured to allow the user to operate the programming for a limited amount of time (e.g., a trial period) after which the programming may automatically become non-operational.

In one embodiment, the website may provide content related to a particular theme. For example, the website content may be targeted towards a particular demographic such as baby boomers. Indeed, baby boomers may be particularly receptive to using the personal information application because some baby boomers may be likely to forget personal information such as that stored in the personal information application or may be uncomfortable using computers and may especially appreciate the convenience provided by the personal information application. Other themes are also possible including teens, pilots, seniors, dentists, doctors, etc.

Website content related to the theme may include, for example: advertising, news, information such as tips and tricks, tutorials, recipes, coupons, and book reviews. Furthermore, the website may provide goods and/or services for sale that are associated with the theme or targeted towards people attracted to the theme. The website may also include content that users may contribute. For example, the website may include personal blogs edited by users, digital photographs uploaded by users, suggestions submitted by users, a calendar for each user that stores the user's appointments and/or reminders and sends notifications to the user of the appointments and/or reminders via email, text message, or instant message. The website may also provide the ability for users of the website to chat with one another via text messages uploaded to the website by the users.

In some cases, the website may feature a particular tip of the week from among a plurality of tips submitted by users. For example, the tip of the week may be a tip related to how to grow tomatoes in a garden.

In some embodiments, the website may provide access to subject matter experts. For example, the website may enable users of the website to ask questions of a gardening expert, fishing expert, or other expert. In some cases, the experts may offer advice in subject areas of interest to those attracted by the theme of the website. The website may collect a fee from the users prior to enabling the users to communicate with the experts.

Some features of the website may require a user to log in (e.g., using a username and password) before the features are made available.

Returning now to the discussion of the personal information application and the storage of personal information, as was described above, in some embodiments, server computing circuitry 502 may store the personal information. In these embodiments, if financial information such as information required to make a credit card purchase (e.g., a credit card number, billing address, cardholder name, security code, and expiration date) is stored by server computing circuitry 502, a user associated with the personal information may make purchases from enterprise 508 using the financial information.

For example, in one embodiment, enterprise 508 may host a website configured to sell goods and/or services in exchange for payment. The enterprise website may allow a user to pay for the goods and/or services by entering the user authentication information associated with the personal information application (described above). After receiving the user authentication information, the enterprise website may provide the user authentication information to server computing circuitry 502. In response, server computing circuitry 502 may provide payment directly to enterprise 508 without providing enterprise 508 with the financial information (e.g., credit card information) and may subsequently use the financial information to obtain payment from the user. In this manner, server computing circuitry 502 may obtain payment without releasing the user's financial information to enterprise 508.

Alternatively, in response to receiving the user authentication information from enterprise 508, server computing circuitry 502 may provide the financial information to enterprise 508 and enterprise 508 may use the financial information to obtain payment from the user. In either case, the user may pay for goods and/or services offered by the enterprise website without having to remember or enter the financial information on the enterprise website. This may advantageously reduce the amount of effort required for a user to make a purchase.

In some embodiments, instead of or in addition to storing the personal information in storage circuitry 702 or storage circuitry 602, the personal information application may store the personal information in a personal access device. The personal access device may be a portable device that the user associated with the personal information may conveniently carry on his person. Using such a personal access device may provide peace of mind to the user since the user may know that his personal information is stored securely in the personal access device instead of in storage circuitry 602 or storage circuitry 702.

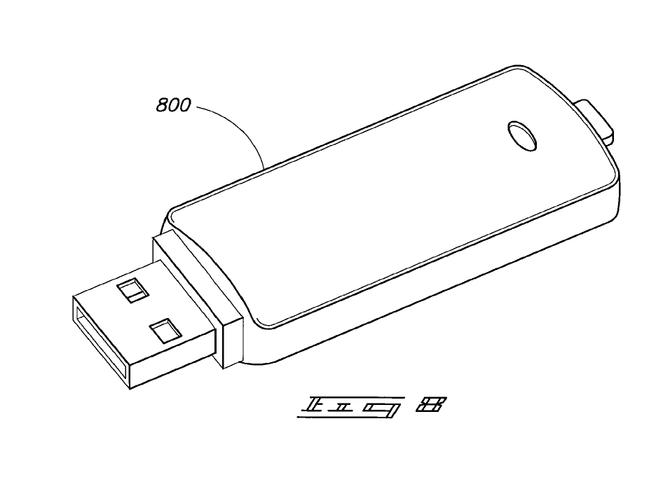

Referring to FIG. 8, an example illustration of one embodiment of a personal access device 800 is illustrated.

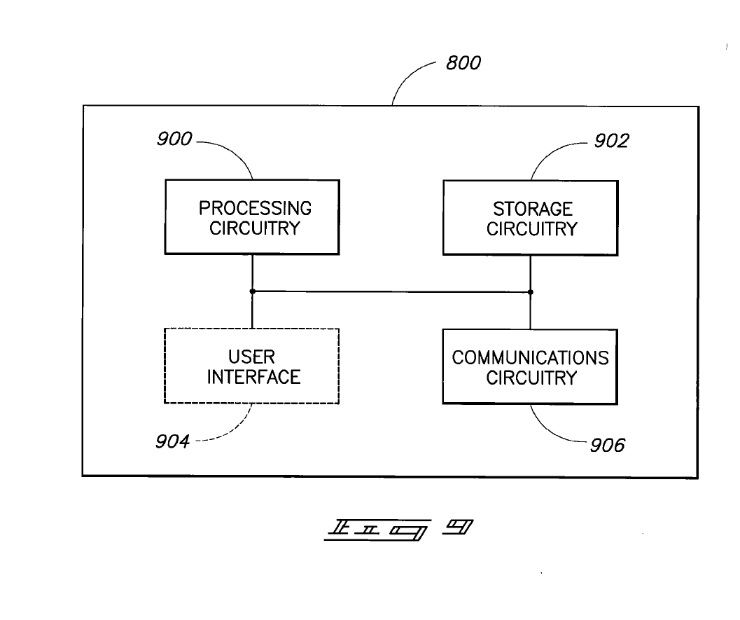

Referring to FIG. 9, a block diagram of personal access device 800 is illustrated. In one embodiment, personal access device 800 includes processing circuitry 900, storage circuitry 902, user interface 904, and communications circuitry 906.

Processing circuitry 900 may comprise circuitry configured to implement desired programming provided by appropriate media in at least one embodiment. For example, processing circuitry 900 may be implemented as one or more of a processor and/or other structure configured to execute executable instructions including, for example, software and/or firmware instructions, and/or hardware circuitry. Exemplary embodiments of processing circuitry 900 include hardware logic, PGA, FPGA, ASIC, state machines, and/or other structures alone or in combination with a processor. These examples of processing circuitry 900 are for illustration and other configurations are possible.

As will be discussed further below, processing circuitry 900 may execute a variety of programming including programming configured to perform one or more of storing, retrieving, encrypting, or decrypting personal information.

Storage circuitry 902 may be embodied in a number of different ways using electronic, magnetic, optical, electromagnetic, or other techniques for storing information. Some specific examples of storage circuitry include, but are not limited to, a portable magnetic computer diskette, such as a floppy diskette, zip disk, hard drive, random access memory, read only memory, flash memory, cache memory, and/or other configurations capable of storing programming, data, or other digital information. In one embodiment, storage circuitry 902 may store programming implemented by processing circuitry 900 including programming embodying the personal information application described herein. Storage circuitry 902 may store the personal information described herein and in some embodiments the stored personal information may be encrypted.

In some embodiments, personal access device 800 may include user interface 904. User interface 904 is configured to interact with a user including conveying data to a user (e.g., displaying data for observation by the user, audibly communicating data to a user, etc.) as well as receiving inputs from the user (e.g., tactile input, voice instruction, etc.). Accordingly, in one exemplary embodiment, the user interface may include a display (e.g., cathode ray tube, LCD, etc.) configured to depict visual information and an audio system as well as a keyboard, mouse and/or other input device. Any other suitable apparatus for interacting with a user may also be utilized.

In one embodiment, a user may use user interface 904 to provide user authentication information (e.g., a password or PIN) to personal access device 800. Accordingly, user interface 904 may be embodied as a keypad or other device capable of receiving alphanumeric input. Alternatively, the user authentication information may be presented as biometric information. Accordingly, user interface 904 may be embodied as a biometric information interface (e.g., a fingerprint reader). In some embodiments, processing circuitry 900 may prevent the personal information from being retrieved and/or decrypted until after the user authentication information is received by user interface 904.

Communications circuitry 906 is configured to communicate with other circuitry such as user computing circuitry 504 and/or devices within network 506. Communications circuitry 906 may communicate with the other circuitry using one or more of a variety of communication channels including wired and/or wireless communication channels. By way of example, communications circuitry 906 may include one or more of a USB interface, an RFID interrogator, an RFID transponder, or a wireless transceiver.

By way of example, personal access device 800 may be embodied as a USB thumb drive or a smart card.

In some embodiments, personal access device 800 may be in communication with user computing circuitry 504 via communications circuitry 906 and communications circuitry 706. For example, in one embodiment, communications circuitry 906 may have a USB interface that is physically connected to a USB interface of communications circuitry 706.

In one embodiment, personal access device 800 may include a connector used to connect personal access device 800 to user computing circuitry 504. The connector may purposely have a shape that is different from commonly used connectors such as a USB or Fire Wire connector so that a consumer can quickly distinguish personal access device 800 from other devices such as USB thumb drives. Furthermore, additionally or alternatively, personal access device 800 may use a communications protocol different from commonly used protocols to distinguish personal access device 800 from other devices.

In another embodiment, communications circuitry 906 may wirelessly communicate with communications circuitry 706 via a wireless channel.

Accordingly, the personal information application may be executed by user computing circuitry 504 (either within an operating system or within a web browser application as described above) and may access the personal information stored by personal access device 800. In some embodiments, the personal information application may retrieve the personal information from personal access device 800 and may temporarily store the personal information in storage circuitry 702. However, the personal information application may be configured to purge the personal information from storage circuitry 702 if the user discontinues using the personal information application or if personal access device 800 is no longer in communication with user computing circuitry 504.

In addition to retrieving personal information stored by personal access device 800, user computing circuitry 504 may receive additional personal information from a user via the personal information application and may forward the additional personal information to personal access device 800 for storage. Upon receiving the additional personal information, storage circuitry 902 may store the additional personal information. In some cases, processing circuitry 700 or processing circuitry 900 may encrypt the additional personal information before the additional personal information is stored by storage circuitry 902.

Furthermore, the personal information application may modify personal information stored in personal access device 800 and/or delete personal information stored in personal access device 800. In some embodiments, processing circuitry 900 may verify that the personal information application is authorized to modify, delete, or add to the personal information stored in personal access device 800 prior to modifying, deleting, or adding to the personal information. For example, processing circuitry 900 may request user authentication information from the personal information application or may request an electronic key or message from the personal information application.

In some embodiments, in addition to storing the personal information, personal access device 800 may additionally store the personal information application. In one embodiment, personal access device 800 may be pre-programmed with the personal information application so that a consumer purchasing personal access device 800 also receives the personal information application. Accordingly, upon establishing communication with personal access device 800, user computing circuitry 504 may retrieve programming embodying the personal information application from personal access device 800 and may subsequently execute the programming using processing circuitry 700.

In some embodiments, personal access device 800 may be built into another device such as a cell phone, personal digital assistant, or other portable electronic device.

Executing the personal information application within a web browser and storing the personal information on personal access device 800 may provide specific advantages. For example, since personal access device 800 may be a portable device, a user may carry personal access device 800 with him. Communications circuitry 906 may be configured with a widely used communications interface, such as a USB connection or a Bluetooth wireless interface. Accordingly, the user may use substantially any computer connected to the Internet that has a communications interface compatible with personal access device 800.

This may be advantageous since the user may use his personal information in substantially any location rather than being confined to computers on which the personal information application has been installed. For example, the user may place personal access device 800 in communication with a computer at a library or internet cafe and then use the personal information application to efficiently gain access to email, websites, personal information, and the like. In one embodiment, kiosk computers may be available for rental in hotels, airports, airplanes, trains, etc. Consumers may rent a kiosk computer and place personal access device 800 in communication with the computer.

In one embodiment, personal access device 800 may include programming that alters the settings of user computing circuitry 504. The settings may be chosen to suit the needs of the user of personal access device 800. For example, personal access device 800 may include programming that changes the default font style and/or size used in a web browser or other application being executed by user computing circuitry 504 to a font style and/or size that is easily read by the user. In some cases, a large font may be chosen by a user that has poor vision or a user that wants to be able to read information presented by user computing circuitry 504 without having to wear reading glasses.

Other settings may also be altered by the programming contained by personal access device 800 such as the size and shape of a pointer controlled by a mouse or other pointing device, background colors, the volume of audio signals generated by user computing circuitry 504, web browser settings, and the ability of user computing circuitry 504 to recognize voice commands issued by the user.

Personal access device 800 may be configured to work with a number of different operating systems such as MICROSOFT WINDOWS®, APPLE® OS X, and Linux.

Personal access device 800 enables a “personality” to be imposed on a computer since personal access device 800 may personalize the appearance of text and pointers and may provide the personal information application, which is familiar to the user. As a result of the “personality” being imposed, the user is enabled to efficiently perform Internet tasks they are accustomed to performing, such as processing email. This may be the case even if the user is using a computer that they have never before operated or is using an unfamiliar operating system. Thus, personal access device 800 may be a highly portable way of quickly customizing substantially any computer with access to the Internet so that the computer can be efficiently used to access Internet information and services in a manner familiar to the user of personal access device 800.

In one embodiment, the personal information application may be executed within a web browser on user computing circuitry 504 and the personal information application may be configured to detect whether personal access device 800 is in communication with user computing circuitry 504 without user intervention.

In one embodiment, processing circuitry 900 or the personal information application may be configured to copy the personal information stored in personal access device 800 to server computing circuitry 502 so that server computing circuitry 502 may store the personal information as a backup in case personal access device 800 is lost or non-functional. Furthermore, server computing circuitry 502 or user computing circuitry 504 may be configured to copy the backup personal information to a replacement personal access device.

In some embodiments, the personal information application may interface with other applications. User computing circuitry 504 may execute the other applications in addition to the personal information application. For example, in one embodiment, retailer 508 may have a website offering goods and/or services for sale. A web browser executed by user computing circuitry 504 may execute programming received from retailer 508. The programming received from retailer 508 may prompt a user to enter payment information for goods and/or services offered by retailer 508. In one embodiment, the programming may determine that personal access device 800 is in communication with user computing circuitry 504. In response to this determination, the programming may allow the user to purchase goods and/or service using personal access device 800.

For example, in one embodiment, the programming may be configured to prompt the user for user authentication information associated with personal information stored by personal access device 800 and may then forward the user authentication information to server computing circuitry 502 for authentication. In response, as was described above, server computing circuitry 502 may forward payment for the goods and/or services to enterprise 508 upon authenticating the user authentication information.

Alternatively, server computing circuitry 502 may forward financial information to enterprise 508 and enterprise 508 may use the financial information to process the purchase as was described above. In this approach, the personal information may include the financial information and the personal information may be stored by server computing circuitry 502 as well as personal access device 800.

In another embodiment, enterprise 508 need not communicate with server computing circuitry 502 to process payment for goods and/or services. Instead, programming from enterprise 508 executing on user computing circuitry 504 may prompt the personal information application, also executing on user computing circuitry 504, to prompt the user for the user authentication information. Upon receiving the user authentication information from the user, the personal information application may authenticate the user authentication information.

The personal information application may then retrieve financial information (such as credit card information as was described above) from personal access device 800 and provide the financial information to enterprise 508 via communication circuitry 706 and network 506. Enterprise 508 may then use the financial information to complete the purchase.

In some embodiments, some portions of the personal information application may be executed by processing circuitry 700 of user computing circuitry 504 and other portions of the personal information application may be executed by processing circuitry 900 of personal access device 800. For example, a portion of the personal information application executed by processing circuitry 900 may perform encryption and decryption of the personal information stored in storage circuitry 902. By way of another example, a portion of the personal information application executed by processing circuitry 900 may authenticate user authentication information supplied by a user prior to allowing access to personal information stored by storage circuitry 902.

In some embodiments, user computing circuitry 504 may be a point of sale terminal. The point of sale terminal may be located at a retailer and may be used by a consumer to purchase goods and/or services from the retailer. In these embodiments, user computing circuitry 504 might not store personal information. Instead, personal information may be stored by individual consumers on personal access devices such as personal access device 800. Accordingly, over time the point of sale terminal may communicate with many different personal access devices owned by respectively different consumers, although the point of sale terminal might not be in communication with more than one personal access device at a time.

In these embodiments, the point of sale terminal may execute the personal information application, although the personal information application might not display the above-described user interfaces. Instead, the personal information application may be configured to deal only with portions of the personal information stored in the personal access device that are related to financial transactions. Accordingly, the personal information application executed by the point of sale terminal might not be configured to access personal information related to email or website authentication information or favorite website addresses that may be stored in the personal access device.

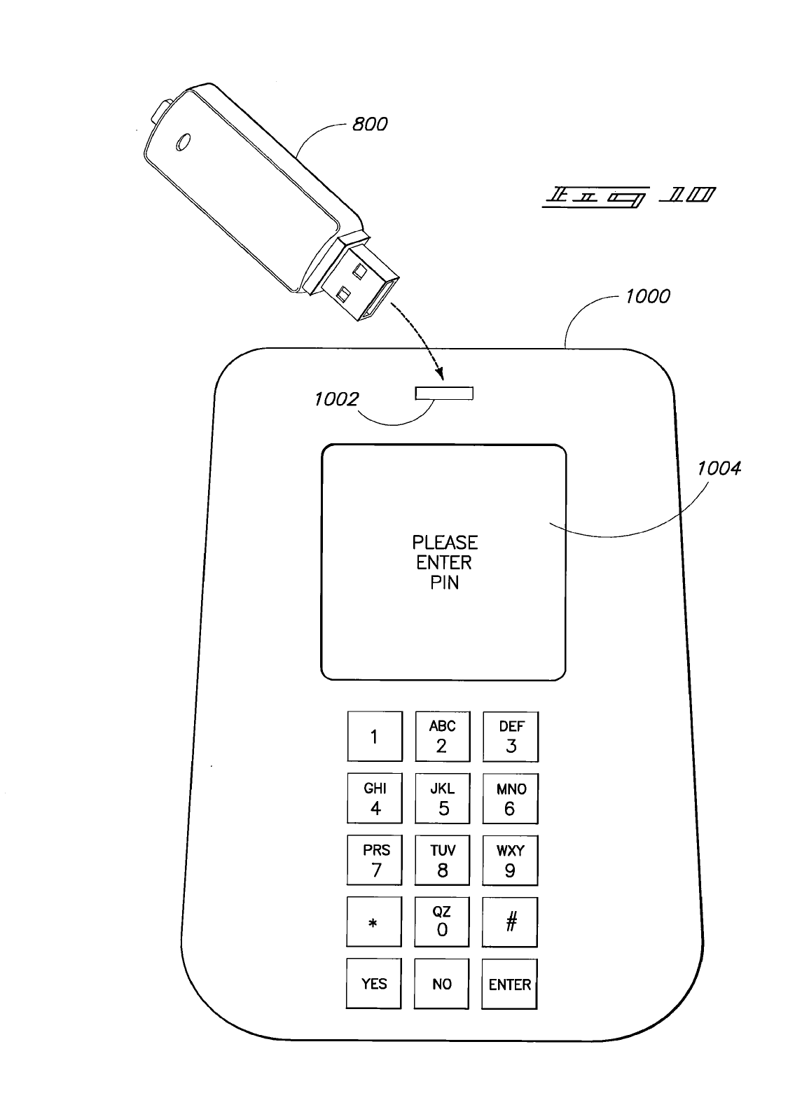

Referring to FIG. 10, a point of sale device 1000 is illustrated. Point of sale device 1000 may be a particular implementation of user computing circuitry 504 in one embodiment. Point of sale device 1000 includes communication interface 1002, which may be part of communications circuitry 706 and interactive display 1004, which may be part of user interface 704.

To make a purchase using point of sale device 1000, a user may position personal access device 800 so that personal access device 800 is in communication (e.g., wired or wireless communication) with point of sale device 1000. For example, in one embodiment, communication interface 1002 may be a USB interface and personal access device 800 may have a USB port. In this embodiment, the user may plug personal access device 800 into communication interface 1002.

Point of sale device 1000 may detect that personal access device 800 is in communication with point of sale device 1000 and in response may prompt the user for user authentication information (e.g., a password or PIN) associated with personal access device 800 via interactive display 1004 as illustrated in FIG. 10. In response, the user may enter the user authentication information via interactive display 1004.

Point of sale device 1000 may authenticate the user authentication information supplied by the user in an effort to ensure that the user who supplied the user authentication information is authorized to use personal access device 800. In some embodiments, point of sale device 1000 may be in communication with server computing circuitry 502 and may request that server computing circuitry 502 authenticate the user authentication information. In other embodiments, point of sale device 1000 may request that personal access device 800 authenticate the user authentication information.

Once the user authentication information has been authenticated, point of sale device 1000 may retrieve financial information (such as credit card information as is discussed above) from personal access device 800 and use the financial information to pay for a purchase of goods and/or services.

In some embodiments, to make a purchase, the user need not supply additional information (such as a credit card number or expiration date) other than the user authentication information to make the purchase. Accordingly, this approach to making purchases may be advantageous to a user since the user might not need to carry a credit card or remember a credit card number to make purchases. Instead, the user need only carry personal access device 800 and remember the user authentication information associated with personal access device 800.

In some cases, financial information for more than one account (e.g., more than one credit card) may be stored by personal access device 800. In these cases, point of sale device 1000 may detect more than one set of financial information and may prompt the user to select which financial information is to be used for the purchase. For example, personal access device 800 may store three sets of financial information respectively for a first credit card, a second credit card, and a debit card. Point of sale device 1000 may detect the presence of these three sets of financial information and may prompt the user to select which of the first credit card, the second credit card, or the debit card should be used for the purchase via interactive display 1004. The user may make a selection using interactive display 1004. In one embodiment, personal access device 800 may indicate which of the three sets of financial information is to be used as a default.

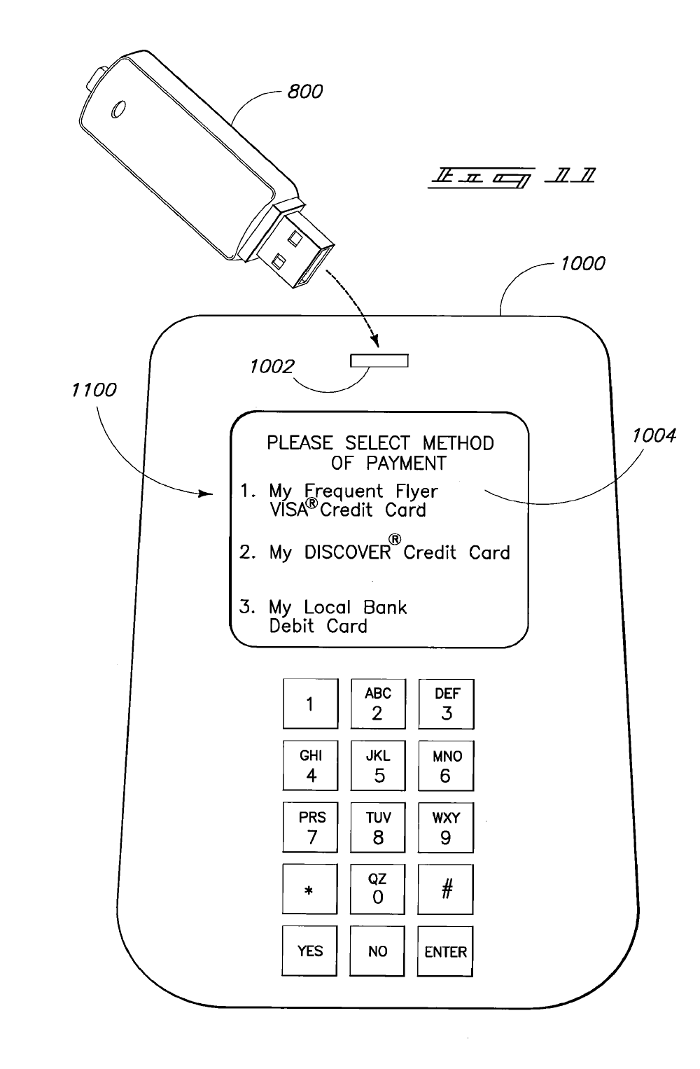

Referring to FIG. 11, a configuration of point of sale device 1000 is illustrated, by way of example, that displays a message 1100 prompting the user to select which of three payment methods will be used for a transaction.

In addition to storing financial information, personal access device 800 may store other information related to retail purchases. For example, personal access device 800 may store information related to a “club card” associated with a retailer. Upon placing personal access device 800 in communication with point of sale device 1000 at the retailer, point of sale device 1000 may retrieve the club card information. Providing the club card information to the retailer may enable the user to receive discounts, accumulate “points,” and/or participate in other incentive programs instituted by the retailer. By storing the club card information in personal access device 800, the user need not remember the club card information or carry the club card with him.

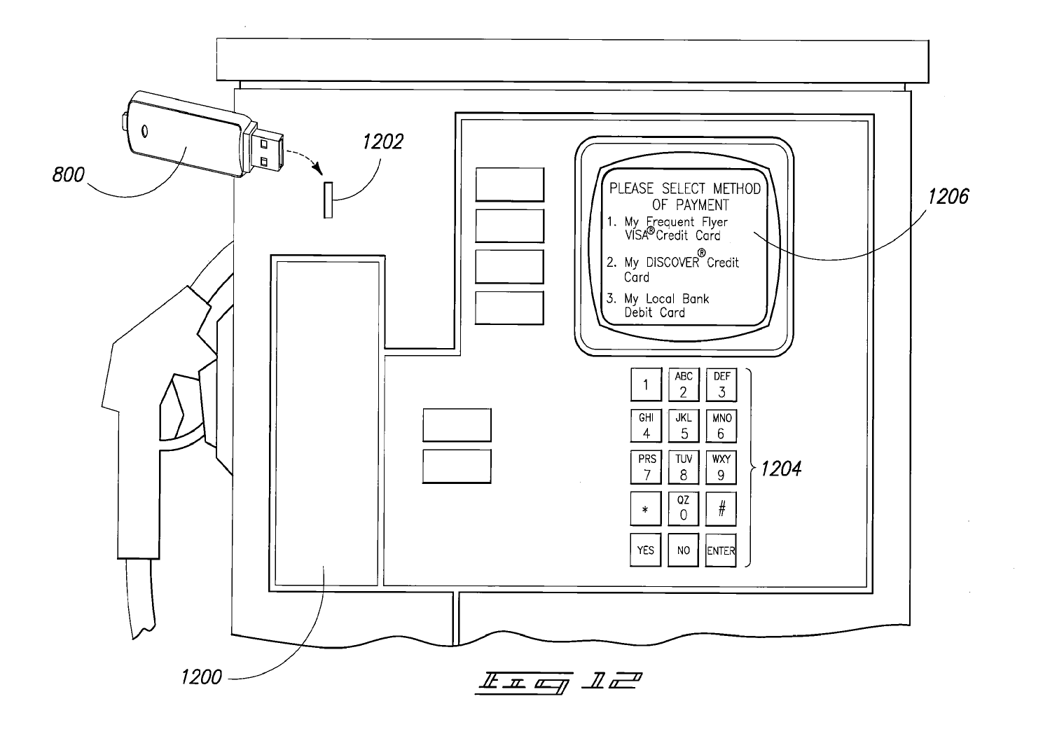

Referring to FIG. 12 another embodiment of a point of sale device 1200 is illustrated. Like point of sale device 1000, point of sale device 1200 may be a particular implementation of user computing circuitry 504 and may be part of a gas pump at a gas station. Point of sale device 1200 may include a display 1206 and keypad 1204, which may be part of user interface 704 as well as a communication interface 1202, which may be part of communications circuitry 706.

Point of sale device 1200 may communicate with personal access device 800 to conduct a purchase in a manner similar to that described above in relation to point of sale device 1000.

Other embodiments of point of sale terminals that implement the functionality of user computing circuitry 504 are also possible. For example, a parking meter or vending machine that includes a point of sale terminal with the functionality of user computing circuitry 504.

In one embodiment, point of sale device 1000 and/or point of sale device 1200 may provide information related to a transaction conducted using information stored by personal access device 800 to personal access device 800 during or after the transaction. For example, information such as the date of the purchase, the location of the purchase, descriptions and prices of items purchased, amount of tax paid, and total transaction amount may be provided to personal access device 800. In some cases, the purchase information may be formatted according to a format compatible with accounting applications such as QUICKBOOKS® or QUICKEN® which are products of Intuit, Inc.

Accordingly, the financial information provided to personal access device 800 may serve as an electronic receipt for the purchase. The user may subsequently download the financial information from personal access device 800 to an accounting application.

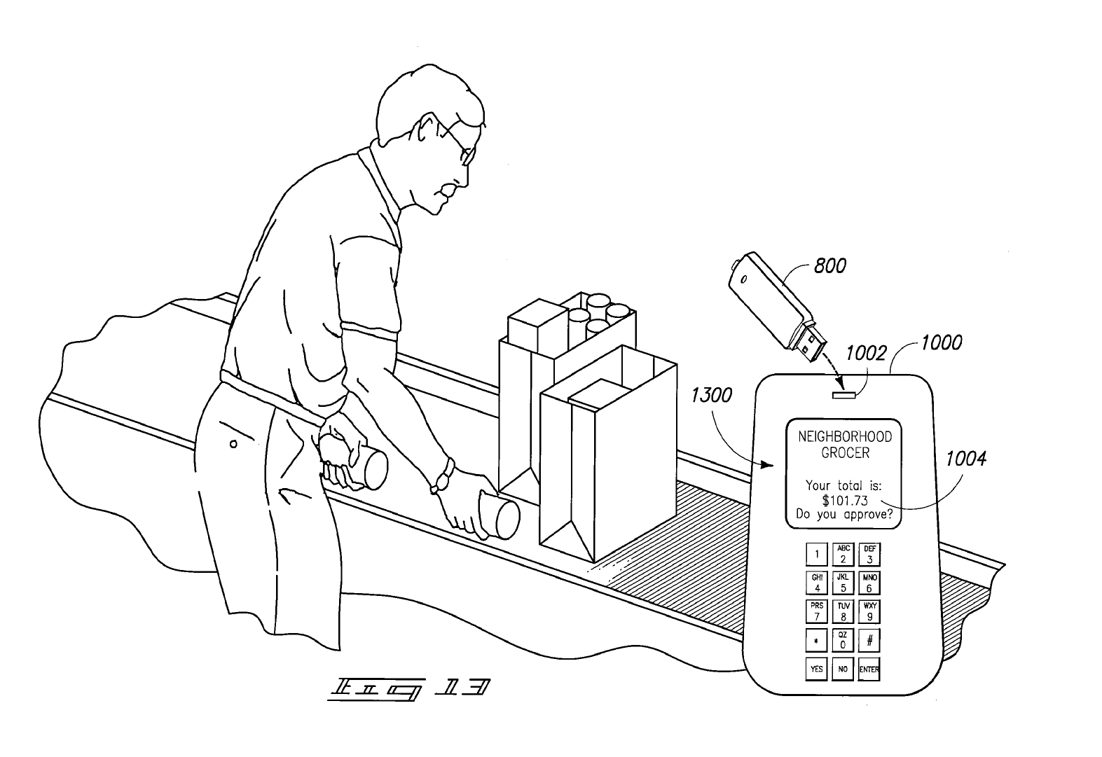

Referring to FIG. 13, a scenario in which a consumer uses point of sale terminal 1000 to purchase groceries is illustrated. Once the groceries to be purchased have been scanned, a total purchase amount for the groceries may be calculated. The consumer may place personal access device 800 in communication with point of sale terminal 1000 (before or after the total purchase amount has been calculated) and enter user authentication information as was described above, thereby enabling point of sale terminal 1000 to access financial information stored by personal access device 800. In some cases, as was described above, the consumer may then select a method of payment for the groceries.

Point of sale terminal 1000 may then display a message 1300 to the consumer asking the consumer to approve the total purchase amount. The consumer may then approve the transaction using, for example, the keypad of point of sale terminal 1000.

Point of sale terminal 1000 may subsequently provide an electronic receipt for the transaction to personal access device 800. Personal access device 800 may store the electronic receipt and the consumer may then take personal access device 800 with him as he leaves the grocery store.

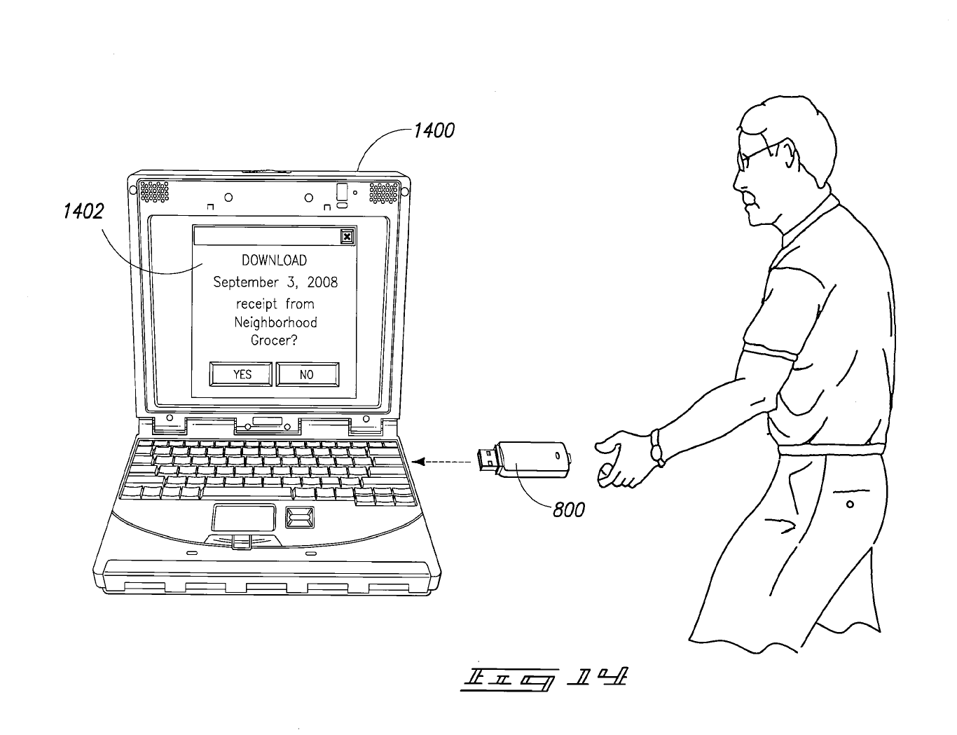

As is illustrated in FIG. 14, the consumer may later place personal access device 800 in communication with a computer 1400. Computer 1400 may then prompt the consumer with message 1402 asking the consumer whether he would like to download the electronic receipt to computer 1400. If the consumer approves, the electronic receipt may be downloaded and may, in some embodiments, be automatically imported into the accounting application described above, saving the consumer from having to manually enter information related to the purchase into the accounting software.

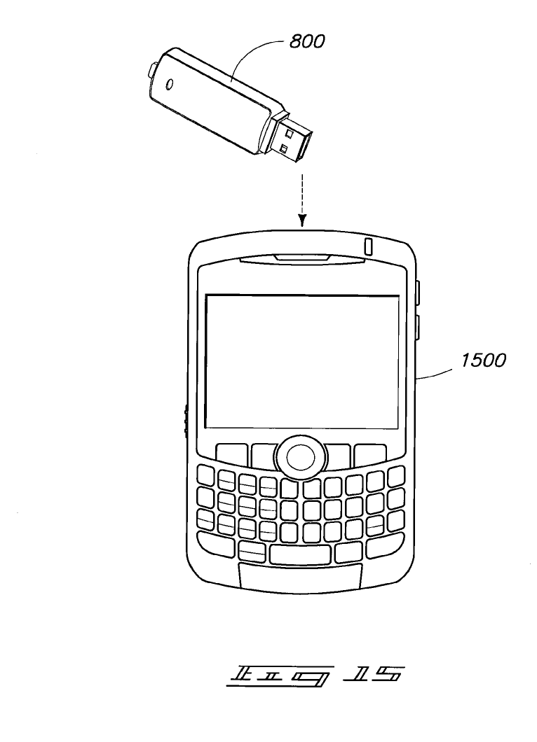

Referring to FIG. 15 a wireless communications device 1500 (e.g., a cellular phone, smart phone, personal digital assistant, etc.) is illustrated. Wireless communications device 1500 may be configured to be in communication with personal access device 800. For example, personal access device 800 may plug into wireless communications device 1500 or personal access device 800 may be in wireless communication with wireless communications device 1500. Wireless communications device 1500 may be a particular implementation of user computing circuitry 504.

Wireless communications device 1500 may execute the personal information application described above and may communicate with personal access device 800 to access the personal information stored by personal access device 800. Wireless communications device 1500 may also be used to make purchases using financial information stored by personal access device 800.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An information access method comprising:
determining that a user desires to access restricted information controlled by an information provider;
without intervention by the user, accessing user authentication information associated with the information provider;
without intervention by the user, providing the user authentication information to the information provider;
without intervention by the user, requesting that the information provider authenticate the user authentication information; and
subsequent to the requesting, providing the user with the restricted information.

2. A consumer purchase method comprising:
a consumer establishing communication between a personal access device and a point of sale terminal, the personal access device storing financial information associated with the consumer;
the point of sale terminal requesting user authentication information associated with the personal access device from the consumer;
based on the user authentication information, the point of sale terminal retrieving the financial information from the personal access device; and
securing payment for goods and/or services using the financial information.
